(19) United States
(12) Patent Application Publication
(10) Pub. No.: US 2026/0133320 A1
(43) Pub. Date: May 14, 2026

(54) OPTOELECTRONIC SENSOR FOR DETECTING OBJECTS IN A MONITORED ZONE

(71) Applicant: SICK AG, Waldkirch (DE)

(72) Inventor: Michael KINGSTON, Waldkirch (DE)

(21) Appl. No.: 19/383,133

(22) Filed: Nov. 7, 2025

(30) Foreign Application Priority Data
Nov. 8, 2024 (DE) 102024132666.2

(51) Int. Cl. G01S 17/894; G01S 7/4914; G01S 7/4915

(52) U.S. Cl. CPC G01S 17/894; G01S 7/4914; G01S 7/4915

(57) ABSTRACT

The invention relates to an optoelectronic sensor, in particular a time-of-flight camera or a LiDAR sensor, for detecting at least one object in a monitored zone, wherein the optoelectronic sensor comprises a light transmitter, a light receiver and an evaluation unit. The light transmitter is configured to transmit transmission light into the monitored zone. The light receiver is configured to receive reception light remitted by the monitored zone. The evaluation unit is configured to obtain distance data about the monitored zone based on the reception light, wherein the distance data comprise intensity values and associated distance values; for all those data portions in the distance data that do not originate from the object, and in particular for all those data portions whose intensity value is smaller than a first intensity limit value, in each case based on the distance data, to determine a distance from the object, in particular from the margin of the object, and, in each case based on the determined distance of the respective data portion from the object, based on a model for the scattered light behavior of the optoelectronic sensor and based on the intensity value of the respective data portion, to determine a probability value that the respective data portion represents an interference; and to recognize all those data portions as interference whose determined probability value is equal to or greater than a probability limit value.

The invention relates to an optoelectronic sensor, in particular a time-of-flight camera or a LiDAR sensor, for detecting at least one object in a monitored zone, wherein the optoelectronic sensor comprises means to recognize data portions in obtained distance data about the monitored zone as interference.

Optoelectronic sensors can be used for industrial safety applications and can allow a safe environmental perception of a monitored zone, and in particular a safe three-dimensional environmental perception of the monitored zone, whereby the safety and efficiency of industrial processes in industrial plants can be increased. Examples of such optoelectronic sensors are ToF (Time-of-Flight) cameras and LiDAR (Light Detection and Ranging) sensors. Optoelectronic sensors can, for example, be attached in a stationary manner in the industrial plant or to robots that can move autonomously in the industrial plant. An industrial plant can, for example, be a production hall, a warehouse, a power plant, a plant in the chemical industry, a plant in the food industry or an animal husbandry facility. Reflectors, in particular retroreflectors, can be attached in the industrial plant and can serve as an obstacle marking/obstacle highlighting and/or as a navigation feature and can be used by optoelectronic sensors on autonomous mobile robots (e.g. AGVs—Autonomous Guided Vehicles) to control, localize and/or navigate the robots.

If there are highly remitting (in particular reflective) objects in the monitored zone, such as reflectors and in particular retroreflectors, warning vests, metallic or reflective objects, the reception light in typical reception optics of optoelectronic sensors can be partly scattered at lens edges and/or other optical elements. This can in particular occur with optoelectronic sensors that scan an environment simultaneously and therefore not in individual measurements. The scattered light can appear as image interference around the object, in particular in front of a simply weakly remitting or distant background, and can lead to distorted distance measurements. The image interference can, in an unwanted manner, trigger a warning field or protective field configured in the optoelectronic sensor, and can thus unnecessarily cause a safety stop of an autonomous robot. This reduces the availability of the robots in their intended use and/or can even render the optoelectronic sensor completely unusable for the use in the industrial plant since they repeatedly trigger a safety stop of the robots at the same positions in the industrial plant (i.e. near the reflectors).

Known optoelectronic sensors attempt to overcome or to avoid the occurrence of image interference by using reception lenses that have fewer internal reflections. However, such reception lenses are complex, expensive, difficult to implement and/or can, where possible, nevertheless only prevent the occurrence of image interference to a limited extent. Other known optoelectronic sensors reduce the intensity of the transmission light. However, a reduction in the transmission light is usually accompanied by a reduction of the range, a reduction of the field of view, detection losses and/or accuracy losses.

The invention is based on the object of providing an improved optoelectronic sensor, in particular with respect to the recognition of image interference.

An optoelectronic sensor having the features of claim 1 is provided to satisfy the object.

The optoelectronic sensor according to the invention, in particular a time-of-flight camera or a LiDAR sensor, for detecting at least one object in a monitored zone, in particular for navigating a vehicle, comprises a light transmitter, a light receiver and an evaluation unit. The light transmitter is configured to transmit transmission light into the monitored zone. The light receiver is configured to receive reception light remitted by the monitored zone. The evaluation unit is configured to obtain distance data about the monitored zone based on the reception light, wherein the distance data comprise intensity values and associated distance values. The evaluation unit is furthermore configured, for all those data portions (e.g. pixels) in the distance data that do not originate from the object, and in particular for all those data portions in the distance data whose (obtained) intensity value is smaller than a (predetermined) first intensity limit value, in each case based on the distance data, to determine a distance from the object, in particular from the margin of the object, and, in each case based on the determined distance of the respective data portion from the object, based on a model for the scattered light behavior of the optoelectronic sensor and based on the intensity value of the respective data portion, to determine a probability value that the respective data portion represents an interference. The evaluation unit is further configured to recognize all those data portions as interference whose determined probability value is equal to or greater than a (predetermined) probability limit value.

In other words, the invention is based on the realization that, for all the data portions in the distance data that do not originate from a (strongly) remitting object (such as a reflector and in particular a retroreflector), a probability value that the respective data portion represents an interference can be determined based on the distance of said data portions from the object, in particular from the margin of the object, based on the intensity value of said data portions and on a calibrated or simulated scattered light model in each case. On the basis of these determined probability values that in the overall context for all the data portions can also be referred to as a probability mask or a probability map, those data portions in the distance data that represent an interference with a certain probability can be recognized and filtered out.

The data portions in the distance data that do not originate from the object can be recognized by common algorithms for image segmentation, and in particular machine learning algorithms. In particular, the fact that the interference caused by scattered light usually has a lower intensity than the remitting object itself can be utilized. Additionally or alternatively, the data portions in the distance data that do not originate from the object can therefore be recognized (and segmented) by filtering by means of a (first) intensity limit value. For all the data portions in the distance data whose intensity value falls below a (first) intensity limit value, i.e. that do not originate from the object, a probability value that the respective data portion represents an interference can be determined (individually) using the scattered light model. On the basis of these determined probability values, the data portions that represent an interference can be filtered out.

When filtering the distance data, the difficulty arises that it is often difficult to recognize whether measurement data are valid (and, for example, only originate from a dark scene) or whether the measurement data actually represent an interference. This is in particular relevant for safety-related applications since all the measurement data that cannot be reliably identified as an incorrect measurement or interference must be retained as far as possible here for reasons of functional safety. In this respect, conventional filters often become more inefficient the closer a pixel in the distance data is to a strongly remitting object. Furthermore, the larger the strongly remitting object in the monitored zone is, the more pronounced the interference can be. The optoelectronic sensor according to the invention with the filtering based on the probability limit value can be more efficient and/or more reliable with respect to the recognition of image interference, in particular in the presence of a strongly remitting object in the monitored zone.

The model for the scattered light behavior of the optoelectronic sensor can be calibrated, created or derived by means of a calibration with real measurement data. The scattered light behavior of the optoelectronic sensor can be known in interaction with the object in the monitored zone (e.g. a retroreflector). In other words, it can be specified that only certain strongly remitting objects, in particular retroreflectors, are located in the monitored zone. By recording distance data about the monitored zone with and without the object, a model for the scattered light behavior can then be calibrated, created or derived. Additionally or alternatively, the model can be calibrated, created or derived by means of a simulation. It is also conceivable that the model is calibrated, created or derived by means of a machine learning algorithm. Using the model for the scattered light behavior that is calibrated, created or derived in this way, an expected intensity deviation per data portion, e.g. per pixel, can be calculated, for example, depending on the object position and object size in the distance data. If the model for the scattered light behavior of the optoelectronic sensor is calibrated, created or derived with respect to an optoelectronic sensor, said model can also be transferred to other optoelectronic sensors with identical or similar reception optics. The process of the calibration can be automated using equipment that repositions the object in the monitored zone.

The distance value of a data portion in the distance data can correspond to a distance measured in meters between the monitored zone (or an object in the monitored zone) and the optoelectronic sensor. The distance of the data portion from the object (or the margin of the object) can correspond to a distance measured in pixels (on the sensor) or can be converted to a distance in meters.

The first intensity limit value can, for example, have a value of an arbitrary unit, for example, 20,000 AU or 20,000 digits. The data portions in the distance data about the object can then have intensity values that are equal to or greater than the first intensity limit value. The first intensity limit value can correspond to the value of the maximum intensity that can be measured by the optoelectronic sensor. In this case, the intensity values in the distance data of the object can assume the value of the first intensity limit value and can be referred to as “overmodulated”.

The first intensity limit value can correspond to a percentage of the maximum intensity that can be measured by the optoelectronic sensor and can, for example, correspond to 50%, preferably 60%, preferably 70%, preferably 80%, preferably 90%, preferably 95%, preferably 99%, and even further preferably 100% (i.e. the saturation value) of the maximum measurable intensity.

The probability limit value can, for example, be 50% (or 0.5), preferably 60%, preferably 70%, preferably 80%, preferably 90%, and even more preferably 95%. The probability limit value can preferably be equal to or greater than 0.5 and less than or equal to 0.7.

It is understood that the evaluation unit can be a part of the optoelectronic sensor or also an external computing unit, e.g. a server, with which the optoelectronic sensor is in a (wireless or wired) signal connection.

The optoelectronic sensor is preferably a safe sensor, i.e. a safety sensor, and in particular a safety ToF camera or a safety LiDAR sensor. The terms safe or safety can in this respect be understood within the meaning of safety-specific standards such as the DIN ISO 13849 or DIN EN 61508 standard. The optoelectronic sensor can therefore allow errors to be controlled up to a certain safety level.

The transmission light is remitted by the object (and also by other items) in the monitored zone as reception light.

According to one embodiment, the object comprises a reflector (e.g. a retroreflector). In particular, the object can be a reflector, and preferably a retroreflector. The retroreflector can preferably reflect the transmission light back to the light transmitter regardless of the angle of incidence. The retroreflector can comprise a plurality of small angled mirrors or hemispherical mirrors that can reflect the light back in the direction of the light transmitter with a small scattering of preferably a few degrees. The reflector can have a remission of equal to or greater than 80%, preferably equal to or greater than 85%, preferably equal to or greater than 90%, preferably equal to or greater than 95%, and preferably equal to or greater than 99%. The intensity values of the reflector in the distance data can have the maximum measurable intensity value (regardless of the distance of the reflector from the optoelectronic sensor), i.e. they can (always) be overmodulated. The reflector, in particular the retroreflector, can be installed in the industrial plant for the purpose of controlling, localizing and/or navigating autonomous robots. It can be specified that only certain reflectors, in particular retroreflectors, are located in the monitored zone.

The evaluation unit can be configured to determine remission values based on the distance data, wherein the remission values can be estimated based on the obtained intensity values and distance values or can be calculated based on the obtained intensity values and distance values. The respective remission value can, for example, be proportional to the obtained intensity value multiplied by the obtained distance value (in meters) squared (remission value˜intensity value*distance value*distance value). The remission can in general estimate a “reflectivity of the observed surface” based on the measured intensity of an object and the measured distance. In other words, an estimate of the material properties of the observed surfaces (or objects), as recognized by the optoelectronic sensor, can be specified. In addition, the remission values can be normalized with the intensity of the transmission light.

According to one embodiment, the distance data comprise a plurality of pixels that each have an intensity value and an associated distance value.

According to one embodiment, the evaluation unit is configured to determine a distance, a size, a remission and/or an intensity of the remitting object based on the distance data. The distance of the object can here mean a distance between the object and the optoelectronic sensor.

According to one embodiment, the probability value P_{BP} that the respective data portion represents an interference is determined using the following equation 1,

$${P}_{B P} ∼ \frac{F ( {x}_{B P} )}{{I}_{B P}} , \qquad [ Equation 1 ]$$

where I_{BP} is the measured intensity value of the respective data portion, x_{BP} is the distance (for example measured in pixels) of the respective data portion from the object, in particular from the margin of the object, and F(x_{BP}) is a scattered light value determined using the model F for the scattered light behavior in dependence on x_{BP}. In other words, I_{BP} can, for example, correspond to the sum of a basic intensity value I_{NoObj} originating from the monitored zone without the object and an intensity value I_{Obj} originating from the object, wherein F(x_{BP}) can correspond to the intensity value I_{Obj} from the object. The probability value P_{BP} can then also be dependent on or correspond to the value 1 minus the ratio of I_{NoObj} to I_{BP} (i.e. 1−I_{NoObj}/I_{BP}). Even if I_{NoObj} is not necessarily known, it can still be known that the ratio of I_{NoObj} to I_{BP} changes with an object. For example, if I_{NoObj} is very similar to I_{BP} or identical thereto (i.e. there is no object in the monitored zone), P_{BP} approaches the value zero. If the basic intensity value I_{NoObj} approaches the value zero, P_{BP} approaches the value 1. Therefore, the closer the data portion is to the object, the more likely it is to represent an interference. A higher basic intensity value I_{NoObj} can lead to a lower probability that the respective data portion represents an interference and/or that the object produces interference.

According to one embodiment, the evaluation unit is configured to determine the probability value that the respective pixel represents an interference in dependence on the determined distance of the respective data portion from the object (in particular from the margin of the object), on the intensity value of the respective data portion, on the maximum measurable intensity (e.g. at a distance of the data portion from an object equal to zero and/or at a distance of the object from the optoelectronic sensor equal to zero) and on the size of the object.

According to one embodiment, the evaluation unit is configured to determine the size of the remitting object based on those data portions in the distance data whose (obtained) intensity value is equal to or greater than the first intensity limit value.

According to one embodiment, the evaluation unit is configured to carry out the recognition of those data portions in the distance data that represent an interference only if the determined size of the object is equal to or greater than a predetermined size limit value, if the determined remission of the object is equal to or greater than a predetermined intensity limit value and/or if the determined intensity of the object is equal to or greater than a second intensity limit value.

The remission limit value described herein can be measured and/or determined using test specimens that are based on a safety-specific standard. According to the safety-specific standard, it can, for example, be required that an object with a 4% remission can still be reliably recognized. Therefore, the remission limit value can, for example, be set at 4% since objects with a lower remission can be ignored.

The second intensity limit value can be equal to the first intensity limit value or higher or lower than it. The size of the object can, for example, be measured based on a number of pixels or, converted, based on a (real) spatial extent. The size of the object (e.g. a retroreflector) can be known. In addition, the object can, as is known, be a very bright, i.e. strongly remitting, object. Based on this, it can then be recognized whether such an object (i.e., for example, a retroreflector) having the specific properties is located in the monitored zone or not. If so, the interference recognition or the recognition (and filtering) of those data portions that represent an interference is carried out. If not, the evaluation unit can cancel the evaluation of the distance data at this point, can skip the recognition of interference and/or can cause a signal to be output. This procedure of the selective recognition (and filtering) can in particular be important for safety applications since it must be avoided as far as possible here that valid measurement data (i.e. data portions of real, existing objects) are inadvertently filtered out. Furthermore, the efficiency of the optoelectronic sensor can be increased in this way. If a plurality of sufficiently large and sufficiently remitting (bright) objects (e.g. retroreflectors) are recognized, the process of the interference recognition described herein can be carried out iteratively for each of these objects.

According to one embodiment, the evaluation unit is configured to determine the size of the object based on those pixels in the distance data whose intensity value is equal to or greater than the first intensity limit value, wherein the size of the object is preferably determined as the number of pixels. The evaluation unit is configured, for each pixel whose intensity value is smaller than the first intensity limit value, to determine a (minimum) distance from the nearest pixel of the object, wherein the distance from the object is preferably determined as the number of pixels. The evaluation unit is configured to determine the probability value that the respective pixel represents an interference in dependence on the intensity value of said respective pixel, on the determined distance of said respective pixel from the nearest pixel of the object, on the maximum measurable intensity and/or the intensity of the object, and on the size of the object, and to recognize all those pixels as interference whose probability value is equal to or greater than the probability limit value.

According to one embodiment, the evaluation unit is configured to determine a distance of the remitting object (from the optoelectronic sensor) based on the distance data, and to recognize all those data portions as interference whose probability value is equal to or greater than the probability limit value and whose associated distance value lies within a tolerance range around the determined distance of the object. This procedure is based on the realization that a data portion that represents an interference usually appears at approximately the same distance from the optoelectronic sensor as the (real) remitting object. Due to the additional filtering according to the tolerance range around the determined distance of the object (or, in other words, according to a distance corridor), a plausibilization of the result of the filtering according to the probability limit value can be achieved. If there are a plurality of remitting objects in the monitored zone, the process can then be carried out and/or iterated separately for each recognized object.

The distance of the object can mean a (mean) relative distance from the optoelectronic sensor. The tolerance range can, for example, comprise a range of ±50 cm, preferably ±20 cm, preferably ±12 cm, preferably ±10 cm, and preferably ±5 cm around the determined distance of the object.

According to one embodiment, the tolerance range comprises a range of ±20%, preferably ±15%, preferably ±10%, preferably ±6%, preferably ±5%, and preferably ±1% of the value of the determined distance of the object (from the optoelectronic sensor) around the determined distance of the object.

According to one embodiment, the evaluation unit is configured to enter each pixel in the distance data whose (obtained) intensity value is equal to or greater than the first intensity limit value into a distance histogram, to recognize a peak in the distance histogram, wherein the peak is preferably the greatest peak (i.e. apex) in the distance histogram, to determine the size of the object based on the number of pixels under the peak, and to determine the distance of the object based on the position of the peak in the distance histogram.

In other words, the distance data are searched for pixels that have an intensity value that is equal to or greater than the first intensity limit value. Such pixels can then also be referred to as overmodulated. Pixels affected by (retro)reflectors are often or even usually overmodulated. Based on the recognized overmodulated pixels, particularly strongly remitting objects (e.g. retroreflectors) can then be recognized and in particular identified.

According to one embodiment, the data portions in the distance data that are recognized as interference are, in particular for the control of the movement of a robot, removed from the distance data, marked as invalid and/or ignored in a further evaluation of the distance data.

A further subject of the invention is a system comprising at least one optoelectronic sensor described herein and at least one autonomous robot, wherein the optoelectronic sensor is preferably attached to the autonomous robot and can be moved along by it.

According to one embodiment, the system comprises a reflector, preferably a retroreflector. The reflector (in particular retroreflector) can be attached in the monitored zone, wherein the robot can move in the monitored zone. The reflector (in particular retroreflector) can serve as an obstacle marking/obstacle highlighting and/or as a navigation feature and can be used by the optoelectronic sensor to control, localize and/or navigate the robot.

A further subject of the invention is the use of an optoelectronic sensor described herein for detecting at least one object in a monitored zone.

A further subject of the invention is a method for detecting at least one object in a monitored zone, wherein transmission light is transmitted into the monitored zone; wherein reception light remitted by the monitored zone is received; wherein distance data about the monitored zone are obtained based on the reception light and are in particular measured by means of a time-of-flight method, wherein the distance data comprise intensity values and associated distance values. Furthermore, for all those data portions in the distance data that do not originate from the object, and in particular for all those data portions whose (obtained) intensity value is smaller than a first intensity limit value, in each case based on the distance data, a distance from the object, in particular from the margin of the object, is determined, and, in each case based on the determined distance of the respective data portion from the object, based on a model for the scattered light behavior of the optoelectronic sensor and based on the intensity value of the respective data portion, a probability value that the respective data portion represents an interference is determined. All those data portions in the distance data are then recognized as interference whose determined probability value is equal to or greater than a predetermined probability limit value.

According to one embodiment, the object comprises a reflector, preferably a retroreflector.

According to one embodiment, a distance, a remission, an intensity and/or a size of the remitting object is/are determined based on the distance data.

According to one embodiment, the probability value that the respective data portion represents an interference is determined in dependence on the determined distance of the respective data portion from the object, on the intensity value of the respective data portion, on the maximum measurable intensity (e.g. when the distance of the data portion from the object is equal to zero and/or when a distance of the object from the optoelectronic sensor is equal to zero) and on the size of the object.

According to one embodiment, all those data portions are recognized as interference whose probability value is equal to or greater than the probability limit value and whose associated distance value lies within a tolerance range around the determined distance of the object.

It is understood that what is described with respect to the optoelectronic sensor according to the invention also applies to the use of the optoelectronic sensor, to the system and to the method. This in particular applies to embodiments and advantages. Furthermore, it is to be understood that all the features and embodiments disclosed herein can be combined unless expressly stated otherwise.

The invention will be described in the following purely by way of example with reference to possible embodiments and to the enclosed drawing. There are shown:

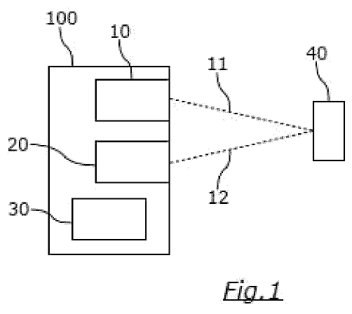

FIG. 1 a schematic representation of an optoelectronic sensor according to an embodiment of the invention;

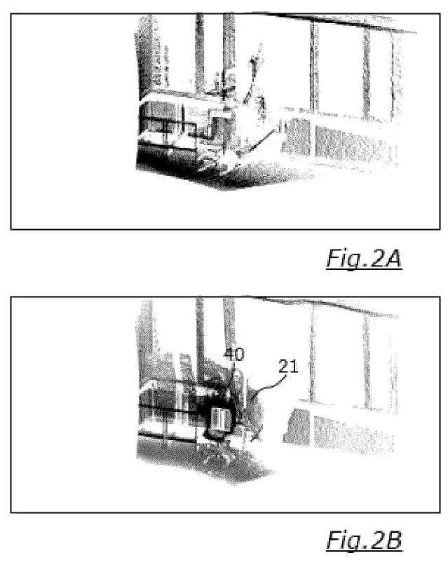

FIG. 2A a bird's eye representation of distance data about a monitored zone obtained by means of an optoelectronic sensor according to an embodiment of the invention;

FIG. 2B a bird's eye representation of distance data about the monitored zone with a strongly remitting object obtained by means of an optoelectronic sensor according to an embodiment of the invention;

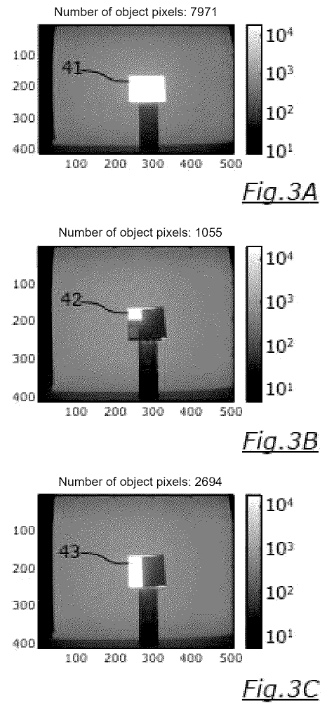

FIG. 3A a central perspective representation of distance data about a first monitored zone with a first test object obtained by means of an optoelectronic sensor according to an embodiment of the invention;

FIG. 3B a central perspective representation of distance data about a second monitored zone with a second test object obtained by means of an optoelectronic sensor according to an embodiment of the invention;

FIG. 3C a central perspective representation of distance data about a third monitored zone with a third test object obtained by means of an optoelectronic sensor according to an embodiment of the invention;

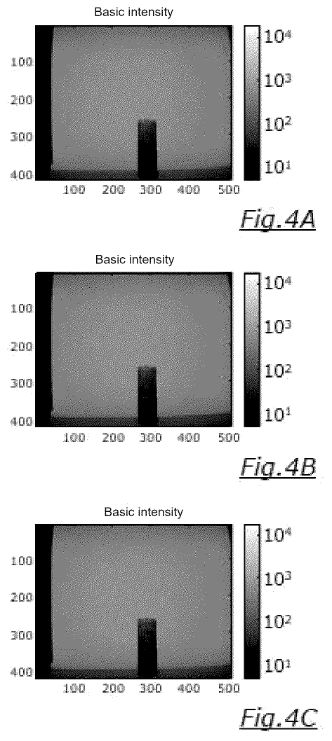

FIG. 4A a central perspective representation of distance data about the first monitored zone without the first test object obtained by means of an optoelectronic sensor according to an embodiment of the invention;

FIG. 4B a central perspective representation of distance data about the second monitored zone without the second test object obtained by means of an optoelectronic sensor according to an embodiment of the invention;

FIG. 4C a central perspective representation of distance data about the third monitored zone without the third test object obtained by means of an optoelectronic sensor according to an embodiment of the invention;

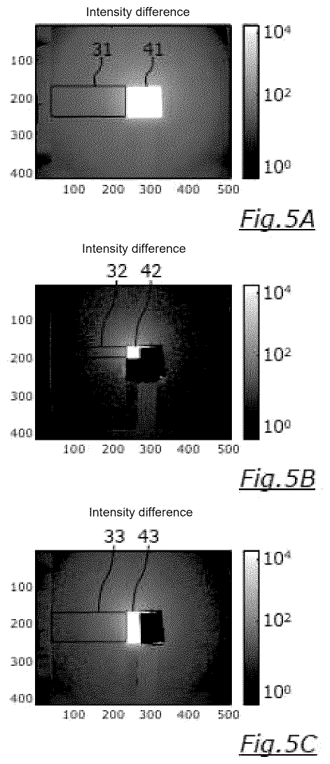

FIG. 5A a central perspective representation of the distance data of the first test object that are adjusted for the basic intensity;

FIG. 5B a central perspective representation of the distance data of the second test object that are adjusted for the basic intensity;

FIG. 5C a central perspective representation of the distance data of the third test object that are adjusted for the basic intensity;

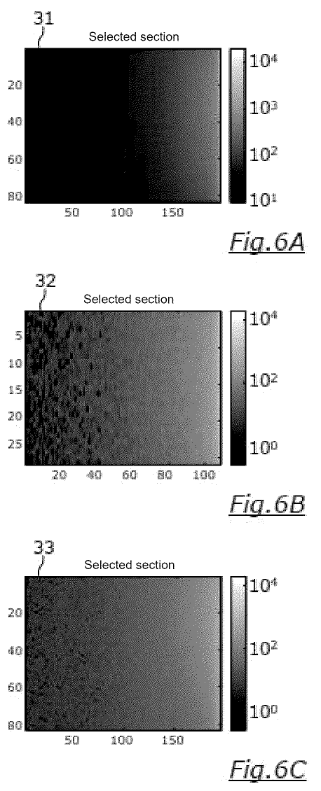

FIG. 6A a representation of a portion of the distance data of the first test object that are adjusted for the basic intensity;

FIG. 6B a representation of a portion of the distance data of the second test object that are adjusted for the basic intensity;

FIG. 6C a representation of a portion of the distance data of the third test object that are adjusted for the basic intensity;

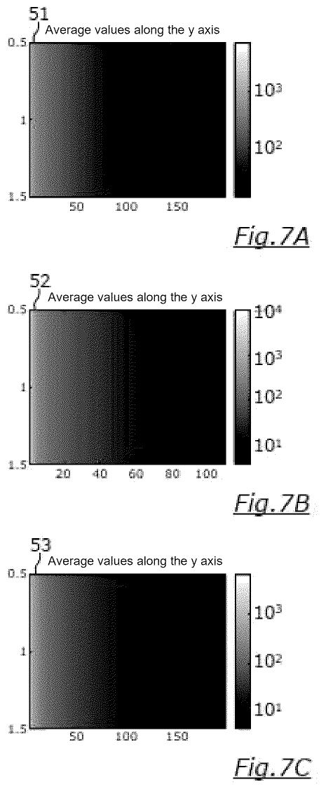

FIG. 7A a representation of the portion of the distance data of the first test object that is averaged along the y axis;

FIG. 7B a representation of the portion of the distance data of the second test object that is averaged along the y axis;

FIG. 7C a representation of the portion of the distance data of the third test object that is averaged along the y axis;

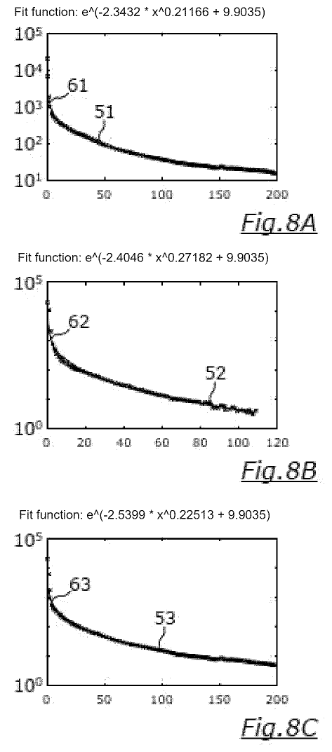

FIG. 8A a graphical representation of a model, calibrated with respect to the first test object, for the scattered light behavior of an optoelectronic sensor according to an embodiment of the invention;

FIG. 8B a graphical representation of a model, calibrated with respect to the second test object, for the scattered light behavior of an optoelectronic sensor according to an embodiment of the invention;

FIG. 8C a graphical representation of a model, calibrated with respect to the third test object, for the scattered light behavior of an optoelectronic sensor according to an embodiment of the invention;

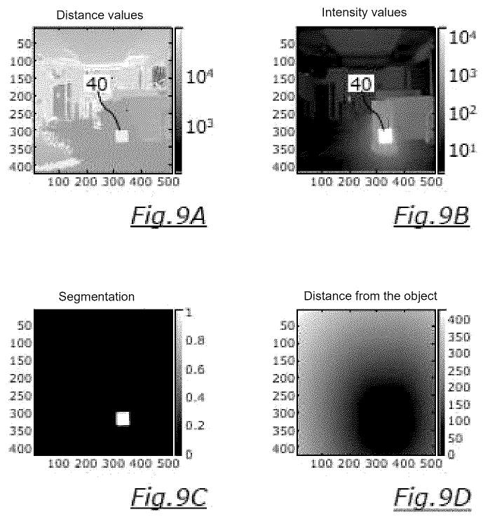

FIG. 9A a central perspective representation of distance values from distance data about a monitored zone with an object obtained by means of an optoelectronic sensor according to an embodiment of the invention;

FIG. 9B a central perspective representation of intensity values from the distance data of the object obtained by means of an optoelectronic sensor according to an embodiment of the invention;

FIG. 9C a representation of a segmentation of the distance data;

FIG. 9D a central perspective representation of the distances of the segmented pixels from the object;

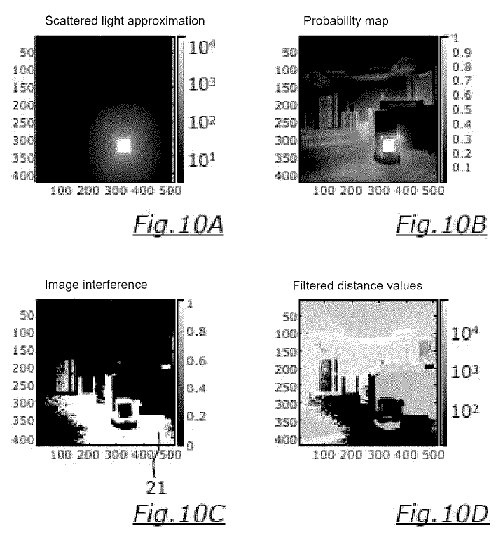

FIG. 10A a representation of the modeled scattered light of the object;

FIG. 10B a central perspective representation of a determined probability map;

FIG. 10C a representation of the recognized image interference;

FIG. 10D a central perspective representation, adjusted for the image interference, of the distance values of the distance data of the object;

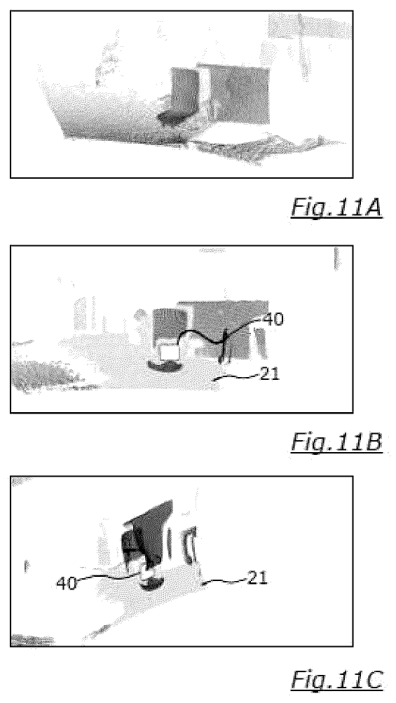

FIG. 11A a bird's eye representation of the distance data about the monitored zone without the object obtained by means of an optoelectronic sensor according to an embodiment of the invention;

FIG. 11B a central perspective representation of the distance data about the monitored zone with the object obtained by means of an optoelectronic sensor according to an embodiment of the invention; and

FIG. 11C a bird's eye representation of the distance data about the monitored zone with the object obtained by means of an optoelectronic sensor according to an embodiment of the invention.

FIG. 1 shows an optoelectronic sensor 100, in particular a time-of-flight camera or a LiDAR sensor, according to an embodiment for detecting at least one object 40 in a monitored zone. The optoelectronic sensor 100 comprises a light transmitter 10, a light receiver 20 and an evaluation unit 30. The light transmitter 10 is configured to transmit transmission light 11 into the monitored zone. The light receiver 20 is configured to receive reception light 12 remitted by the monitored zone, and in particular by the object 40 in the monitored zone. The evaluation unit 30 is configured to obtain distance data about the monitored zone based on the reception light 12, wherein the distance data comprise intensity values and associated distance values. The evaluation unit 30 is furthermore configured, for all those data portions (e.g. pixels) in the distance data that do not originate from the object 40, and in particular for all those data portions in the distance data whose intensity value is smaller than a first intensity limit value, to determine a respective distance from the object 40 (e.g. in pixels), in particular from the margin of the object 40, and, in each case based on the determined distance of the respective data portion, based on a model for the scattered light behavior of the optoelectronic sensor 100 and based on the intensity value of the respective data portion, to determine a probability value that the respective data portion represents an interference; and to recognize all those data portions as interference whose determined probability value is equal to or greater than a probability limit value.

The evaluation unit 30 of the optoelectronic sensor shown in FIG. 1 can be configured, based on the distance data, to determine a distance (from the optoelectronic sensor, e.g. in meters), a size, an intensity and/or a remission of the remitting object 40. The evaluation unit 30 can, for example, determine the size of the remitting object 40 based on those data portions in the distance data whose intensity value is equal to or greater than the first intensity limit value.

The evaluation unit 30 of the optoelectronic sensor 100 shown in FIG. 1 can be configured to determine the distance of the object 40 (only) if and/or to carry out the recognition of those data portions in the distance data that represent an interference (only) if the size of the object 40 is equal to or greater than a predetermined size limit value if the intensity of the object 40 is equal to or greater than a predetermined second intensity limit value and/or if the remission of the object is greater than or equal to a remission limit value. In this way, it can be avoided that valid data portions (i.e. data portions of real, existing objects) are inadvertently filtered out, which is particularly important for safety applications. If a plurality of sufficiently large objects remitting to a sufficient extent are recognized or detected, the process of the interference recognition can be iteratively carried out for each of the recognized objects.

The evaluation unit 30 of an optoelectronic sensor 100, as is shown, for example, in FIG. 1, can be configured to recognize all those data portions (e.g. pixels) as interference whose probability value is equal to or greater than the probability limit value and whose associated distance value is within a tolerance range around the determined distance of the object 40 (from the optoelectronic sensor).

FIG. 2A and FIG. 2B show a bird's-eye representation of distance data about a monitored zone without or with a strongly remitting object 40 obtained by means of an optoelectronic sensor 100, as is shown, for example, in FIG. 1. As shown in FIG. 2A and FIG. 2B, the obtained distance data can comprise a plurality of pixels that each have an intensity value and an associated distance value.

In particular in the case of a simultaneous scanning of the monitored zone (in contrast to a scanning in individual measurements), scattered light in the optics of the light receiver 20 of the optoelectronic sensor 100 can make a correct distance measurement more difficult or prevent it. A strong remission of the transmission light by a remitting object 40, for example a retroreflector, can lead to distorted distance measurements around the image region of the object 40. Typically, this image interference 21 is produced when the scattered light is energetically higher than the basic level or the basic intensity that is remitted back by the monitored zone, which can in particular be the case with a dark or distant background.

FIG. 2A and FIG. 2B illustrate such a situation using a scene with a chair in front of a plurality of windows, with the windows serving as a substitute for a dark background here. As can be seen in FIG. 2A, a noise of the distance values can be observed in the region of the windows, wherein these noise values are, however, still easily recognizable as such and can therefore be controlled. As soon as a strongly remitting object 40, in this case a retroreflector, is placed on the chair as shown in FIG. 2B, all the noise values or image interference 21 assume the distance of the object 40. The scattered light overwrites some or all of the pixels in the environment of the object 40 that do not emit strongly enough themselves. A spherical image interference or an artifact formed from a cloud of pixels 21 is produced, wherein the radius of the spherical artifact can correspond to the distance of the object 40 and the center can correspond to the position of the optoelectronic sensor 100 (not shown in FIGS. 2A and 2B).

In short, the pixels 21 shown in FIG. 2B can arise due to multiple reflections and a scattering of the reception light at optical elements in the light receiver 20 of the optoelectronic sensor 100. These pixels 21 represent interference and can trigger a warning field or protective field configured in the optoelectronic sensor 100. As a result, a safety stop of an autonomous robot can unnecessarily be caused, which robot can move in an industrial plant and can in particular move in the monitored zone in the industrial plant. It is understood that the optoelectronic sensor 100, as is shown in FIG. 1, can be attached to the autonomous robot and can in particular be moved along by it.

The procedures described herein allow the recognition (and filtering) of those pixels that have been overwritten by scattered light with a certain probability. In this respect, a model for the scattered light behavior of the optoelectronic sensor 100 is used that can also be viewed as an approximation of the region of influence of the remitting object 40 in interaction with the optics of the light receiver 20.

FIG. 3A to FIG. 8C illustrate how a model for the scattered light behavior of the optoelectronic sensor can be created and/or calibrated in relation to specific objects in the monitored zone. The procedure described herein is based on the fact that the scattered light behavior of the optics of the light receiver 20 of the optoelectronic sensor 100, such as is shown in FIG. 1, can be known in interaction with certain (test) objects 41, 42, 43. Based on distance measurements of an otherwise identical monitored zone with and without a test object, the model for the scattered light behavior can be calibrated with respect to a specific test object 41, 42, 43. The test objects described herein can be retroreflectors. The calibration can take place by recording real measurement data, as illustrated in FIG. 3A to FIG. 8C. Additionally or alternatively, a model for the scattered light behavior can also be simulated.

FIG. 3A, FIG. 3B and FIG. 3C each show a central perspective representation of distance data, or more precisely of the intensity values from the distance data, about a first, second and third monitored zone with a strongly remitting first test object 41, second test object 42 and third test object 43, obtained by means of an optoelectronic sensor 100, such as is shown in FIG. 1. The size of the first test object 41 determined by means of the evaluation unit 30 of the optoelectronic sensor 100 is 7971 pixels, the size of the second test object 42 is 1055 pixels and the size of the third test object 43 is 2964 pixels.

FIG. 4A, FIG. 4B and FIG. 4C each show a central perspective representation of distance data, more precisely of the intensity values from the distance data, about the first, second and third monitored zone without the test objects 41,42,43 obtained by means of an optoelectronic sensor 100, such as is shown in FIG. 1. The distance data shown in FIG. 4A, FIG. 4B and FIG. 4C represent a recording of the basic level or the basic intensity of the respective monitored zone.

FIG. 5A, FIG. 5B and FIG. 5C each show a central perspective representation of the distance data, or more precisely of the intensity values, of the first test object 41, the second test object 42 and the third test object 43, said distance data adjusted for the respective basic intensity (for example by subtraction). In FIG. 5A, FIG. 5B and FIG. 5C, a selected portion 31, a selected portion 32 and a selected portion 33 are each marked with a rectangle, wherein these portions are shown in more detail in FIG. 6A, FIG. 6B and FIG. 6C. The portions 31, 32, 33 show the intensity development from the margin of the respective test object 41, 42, 43 to the outside and in particular to the (left) side of the respective monitored zone.

As shown in FIG. 7A, FIG. 7B and FIG. 7C, the selected portions 31, 32, 33 are averaged along the y axis. The data points 51, 52, 53 obtained in this way are graphically marked as crosses in FIG. 8A, FIG. 8B and FIG. 8B. To approximate the intensity deviation due to the scattered light, a fit function 61, 62, 63 can in each case be approximated to the data points in accordance with the following general equation 2,

$$F ( x ) = {e}^{( a \cdot {x}^{b} + c )} = {e}^{( a \cdot {x}^{b} )} \cdot {e}^{c} , \qquad [ Equation 2 ]$$

where x in equation 2 is the distance (e.g. measured in pixels) of the respective data point from the test object 41, 42, 43, in particular from the margin of the test object 41, 42, 43, where the parameter a can assume a value between −2.3 and −2.6, the parameter b can assume a value between 0.2 and 0.3, and the parameter c is calculated based on the maximum intensity Iₘₐₓ (here 20,000 AU) that can be measured by the optoelectronic sensor 100 in accordance with the following equation 3

$$c = log ( {I}_{max} ) = log ( 20000 ) = 9 , 9035. \qquad [ Equation 3 ]$$

Equation 2 can also be viewed as a generalized model for the scattered light behavior of the optoelectronic sensor 100.

The first fit function 61 for the first test object 41, the second fit function 62 for the second test object 42 and the third fit function 63 for the third test object 43 are each marked as a continuous line in FIG. 8A, FIG. 8B or FIG. 8C. In the first fit function 61 for the first test object 41 shown graphically in FIG. 8A, the parameter a has a value of −2.3432, the parameter b has a value of 0.21166 and the parameter c has a value of 9.9035. In the second fit function 62 for the second test object 42 shown graphically in FIG. 8B, the parameter a has a value of −2.4046, the parameter b has a value of 0.27182 and the parameter c has a value of 9.9035. In the third fit function 63 for the third test object 43 shown graphically in FIG. 8C, the parameter a has a value of −2.5399, the parameter b has a value of 0.22513 and the parameter c has a value of 9.9035. In this way, a model for the scattered light behavior of the optoelectronic sensor 100 can be calibrated for each known (test) object, e.g. for each known reflector type.

It can be seen from the measurements that the values of the parameters a and b in the model for the scattered light behavior according to equation 2 can be dependent on the size (i.e. on the number of pixels) of the test object 41, 42, 43. In other words, the parameter a can be selected based on the size of the test object (or on the number of determined pixels of the test object) and can assume a value between −2.3 and −2.6. Additionally or alternatively, the parameter b can be selected based on the size of the test object (or on the number of determined pixels of the test object) and can assume a value between 0.2 and 0.3. The parameter b can assume a larger value, the smaller the test object 41, 42, 43 is. This can mean that for other objects with respect to which no calibration has yet been carried out, the values for the parameters a and b can be selected in dependence on the determined size of the object 40, for example, by using a pre-calibrated function or interpolation of values taken from a pre-created look-up table.

FIG. 9A to FIG. 11C illustrate how interference in distance data obtained by an optoelectronic sensor 100 can be recognized and filtered.

FIG. 9A and FIG. 9B show a central perspective representation of distance values or intensity values from distance data about a monitored zone with an object 40 obtained by means of an optoelectronic sensor 100, such as is shown in FIG. 1.

The pixels that do not originate from the object 40 shown in FIG. 9A or FIG. 9B can, or example, be recognized and segmented (and/or binarized) based on an intensity limit value. For example, all the pixels that have an intensity value of less than 90%, preferably 95%, preferably 99% and even more preferably 100% of the maximum intensity that can be measured by the optoelectronic sensor, in this case 20,000 AU, can be recognized and, as shown in black in FIG. 9C, can be set to the value zero in the segmentation. The remaining pixels that have an intensity value of equal to or greater than the intensity limit value, i.e. the pixels of the object 40, are assigned the value 1 in the segmentation. In FIG. 9C, the pixels of the object 40 are shown in white, wherein an intensity limit value of 19,000 AU has been applied.

For all the segmented pixels (i.e. pixels that do not originate from the object 40), a (minimum) distance from the nearest pixel of the object 40 is determined, as shown in FIG. 9D. As is known, the object 40 can correspond to the first test object 41 so that a model for the scattered light behavior, i.e. the fit function 61 from FIG. 8A, is already calibrated with respect to the object 40. FIG. 10A shows the scattered light with respect to the object 40 that is approximated based on the known model for the scattered light behavior, i.e. the fit function 61 from FIG. 8A. For each segmented pixel, based on its determined distance from the object 40, its intensity value and the scattered light approximated according to the model for the distance of the pixel, a probability value that the respective pixel represents an image interference can be determined. More precisely, the scattered light approximated for the distance of the respective pixel is divided by the intensity value of the respective pixel (according to equation 1). This procedure is based on the realization that the greater the original intensity value of a pixel in relation to the scattered light of the object 40 is, the less likely it is that this pixel has been overwritten by scattered light. Conversely, a pixel with a low intensity value in the vicinity of the object 40 will have been overwritten by scattered light with a greater probability. The probability values determined in this way for the segmented pixels are shown in the probability map in FIG. 10B.

Those pixels 21 of the segmented pixels that represent an interference with a certain probability can be recognized and segmented (and/or binarized) based on a probability limit value. For example, all the pixels 21 that have a probability value of equal to or greater than a probability limit value of 0.5 can be recognized and, as shown in white in FIG. 10C, can be set to the value 1 in the segmentation. The remaining pixels of the segmented pixels that have a probability value of less than 0.5, and therefore probably do not represent an interference, are assigned the value zero. In FIG. 10C, these pixels that are valid (with a certain probability) are shown in black. The representation in FIG. 10C can also be described as an image interference mask.

Optionally, the image interference mask in FIG. 10C can be improved with a plausibilization using the distance values in FIG. 9A. Since the image interference usually has the same (radial) distance value as the distance of the object 40 itself, all those pixels can be retained in the image interference mask in FIG. 10C whose associated distance value lies within a tolerance range (or distance corridor) around the distance of the object 40 determined based on the distance data in FIG. 9A.

The distance values of the distance data in FIG. 9A can then be filtered using the image interference mask, as shown in FIG. 10D. The distance values of the recognized pixels 21 that represent an interference can then be invalidated and can, for example, be set to zero as shown in FIG. 10D.

FIG. 11A shows a (three-dimensional) bird's eye representation of the distance data about the monitored zone from FIG. 9A to FIG. 10D without the object 40 obtained by means of an optoelectronic sensor according to an embodiment of the invention. FIG. 11B and FIG. 11C each show a (three-dimensional) central perspective representation or bird's-eye representation of the filtered distance data from FIG. 10D, wherein the pixels 21 recognized as interference (as described herein) are highlighted.

By means of the procedures described herein, image interference caused by strongly remitting objects, e.g. retroreflectors, can be recognized. Optoelectronic (industrial) sensors can be enabled to mask or ignore (reflector) interference. Furthermore, the knowledge of the position, size and shape of objects, e.g. retroreflectors, in the field of view of the optoelectronic sensor can be used to bring about an appropriate system response, such as the automatic adaption of the protective field geometry with the simultaneous reduction of the travel speed of an autonomous robot. In all the cases, the availability of the optoelectronic sensor can be improved, which can generally be regarded as an important quality criterion.

1. An optoelectronic sensor for detecting at least one object in a monitored zone,
wherein the optoelectronic sensor comprises a light transmitter, a light receiver and an evaluation unit,
wherein the light transmitter is configured to transmit transmission light into the monitored zone,
wherein the light receiver is configured to receive reception light remitted by the monitored zone, and
wherein the evaluation unit is configured
to obtain distance data about the monitored zone based on the reception light, wherein the distance data comprise intensity values and associated distance values;
for all those data portions in the distance data that do not originate from the object,
in each case based on the distance data, to determine a distance from the object and,
in each case based on the determined distance of the respective data portion from the object, based on a model for the scattered light behavior of the optoelectronic sensor and based on the intensity value of the respective data portion, to determine a probability value that the respective data portion represents an interference; and
to recognize all those data portions as interference whose determined probability value is equal to or greater than a probability limit value.

2. The optoelectronic sensor according to claim 1, wherein the optoelectronic sensor is one of a time-of-flight camera and a LiDAR sensor.

3. The optoelectronic sensor according to claim 1, wherein the evaluation unit is further configured to determine the probability value that the respective data portion represents the interference for all those data portions whose intensity value is smaller than a first intensity limit value.

4. The optoelectronic sensor according to claim 1, wherein the evaluation unit is configured in each case based on the distance data to determine a distance from a margin of the object.

5. The optoelectronic sensor according to claim 1, wherein the evaluation unit is configured to determine a distance, a size, an intensity and/or a remission of the emitting object based on the distance data.

6. The optoelectronic sensor according to claim 5, wherein the probability value that the respective data portion represents an interference is determined in dependence on the determined distance of the respective data portion from the object, on the intensity value of the respective data portion, on the maximum measurable intensity, and on the size of the object.

7. The optoelectronic sensor according to claim 5, wherein the evaluation unit is configured to determine the size of the remitting object based on those data portions in the distance data whose intensity value is equal to or greater than the first intensity limit value.

8. The optoelectronic sensor according to claim 5, wherein the evaluation unit is configured to carry out the recognition of those data portions in the distance data that represent an interference only if the determined size of the object is equal to or greater than a predetermined size limit value, if the determined remission of the object is equal to or greater than a predetermined second intensity limit value and/or if the determined intensity of the object is equal to or greater than a predetermined second intensity limit value.

9. The optoelectronic sensor according to claim 5,
wherein the distance data comprise a plurality of pixels that each have an intensity value and an associated distance value, and
wherein the evaluation unit is configured
to determine the size of the object based on those pixels in the distance data whose intensity value is equal to or greater than the first intensity limit value and,
for each pixel whose intensity value is smaller than the first intensity limit value,
to determine a distance from the nearest pixel of the object, and
to determine the probability value that the respective pixel represents an interference in dependence on the intensity value of said respective pixel, on the determined distance of said respective pixel from the nearest pixel of the object, on the maximum measurable intensity and/or the intensity of the object, and on the size of the object, and
to recognize all those pixels as interference whose probability value is equal to or greater than the probability limit value.

10. The optoelectronic sensor according to claim 9,
wherein the size of the object is determined as the number of pixels.

11. The optoelectronic sensor according to claim 10, wherein the distance from the object is determined as the number of pixels.

12. The optoelectronic sensor according to claim 1, wherein the evaluation unit is configured
to determine a distance of the remitting object based on the distance data, and
to recognize all those data portions as interference whose probability value is equal to or greater than the probability limit value and whose associated distance value lies within a tolerance range around the determined distance of the object.

13. The optoelectronic sensor according to claim 12,
wherein the distance data comprise a plurality of pixels that each have an intensity value and an associated distance value, and
wherein the evaluation unit is configured
to enter each pixel in the distance data whose intensity value is equal to or greater than the first intensity limit value into a distance histogram,
to recognize a peak in the distance histogram,
to determine the size of the object based on the number of pixels under the peak, and
to determine the distance of the object based on the position of the peak in the distance histogram.

14. The optoelectronic sensor according to claim 13,
wherein the peak is the greatest peak in the distance histogram.

15. The optoelectronic sensor according to claim 1, wherein the data portions in the distance data that are recognized as interference are removed from the distance data, marked as invalid and/or ignored in a further evaluation of the distance data.

16. The optoelectronic sensor according to claim 15, wherein the data portions in the distance data that are recognized as interference are for the control of the movement of a robot.

17. The optoelectronic sensor according to claim 1, wherein the object comprises a reflector.

18. The optoelectronic sensor according to claim 17, wherein the reflector is a retroreflector.

19. A system comprising at least one optoelectronic sensor and at least one autonomous robot, wherein the optoelectronic sensor comprises a light transmitter, a light receiver and an evaluation unit,
wherein the light transmitter is configured to transmit transmission light into the monitored zone,
wherein the light receiver is configured to receive reception light remitted by the monitored zone, and
wherein the evaluation unit is configured
to obtain distance data about the monitored zone based on the reception light, wherein the distance data comprise intensity values and associated distance values,
for all those data portions in the distance data that do not originate from the object,
in each case based on the distance data, to determine a distance from the object and,
in each case based on the determined distance of the respective data portion from the object, based on a model for the scattered light behavior of the optoelectronic sensor and based on the intensity value of the respective data portion, to determine a probability value that the respective data portion represents an interference; and
to recognize all those data portions as interference whose determined probability value is equal to or greater than a probability limit value.

20. The system according to claim 19, wherein the optoelectronic sensor is attached to the autonomous robot and can be moved along by it.

21. A method for detecting at least one object in a monitored zone,
wherein transmission light is transmitted into the monitored zone;
wherein reception light remitted by the monitored zone is received;
wherein distance data about the monitored zone are obtained based on the reception light, wherein the distance data comprise intensity values and associated distance values;
wherein, for all those data portions in the distance data that do not originate from the object
in each case based on the distance data, a distance from the object is determined, and,
in each case based on the determined distance of the respective data portion from the object, based on a model for the scattered light behavior of the optoelectronic sensor and based on the intensity value of the respective data portion, a probability value that the respective data portion represents an interference is determined; and
wherein all those data portions in the distance data are recognized as interference whose determined probability value is equal to or greater than a predetermined probability limit value.

22. The method according to claim 21,
wherein the object is one of a reflector and a retroreflector.

23. The method according to claim 21, wherein the probability value that the respective data portion represents an interference is determined for all those data portions whose intensity value is smaller than a first intensity limit value.

24. The method according to claim 21, wherein the distance from the object that is determined is a distance from the margin of the object.

25. The method according to claim 21, wherein the distance data about the monitored zone are measured by means of a time-of-flight method.

26. The method according to claim 21,
wherein a distance of the remitting object is determined based on the distance data; and
wherein all those data portions are recognized as interference whose probability value is equal to or greater than the probability limit value and whose associated distance value lies within a tolerance range around the determined distance of the object.
